(19) United States
(12) Patent Application Publication
(10) Pub. No.: US 2021/0294966 A1
(43) Pub. Date: Sep. 23, 2021

(54) SYSTEMS AND METHODS FOR BINDING LOOKUP CONTROLS

(71) Applicant: GLOBAL SOFTWARE INNOVATION PTY LTD, Baulkham Hills (AU)

(72) Inventors: Peter Kyra AYLETT, North Ryde (AU); Diana Sandra WALKER, Glenbrook (AU); Constantino CHRISTOU, Collaroy Plateau (AU)

(21) Appl. No.: 16/334,526

(22) PCT Filed: Sep. 6, 2017
(86) PCT No.: PCT/AU2017/000185

§ 371 Date: Mar. 19, 2019

(30) Foreign Application Priority Data
Sep. 20, 2016 (AU) 2016231507

(51) Int. Cl. G06F 40/174; G06F 3/0482; G06F 3/0484

(52) U.S. Cl. CPC G06F 40/174; G06F 3/04847; G06F 3/0482

(57) ABSTRACT

A method for binding two or more lookup controls for use in a computer generated input form is described. The method comprises selecting two or more lookup controls for use in the computer generated input form; binding a relationship type from an entity-relationship schema to each of the two or more lookup controls; determining if one or more relationship types exist between the two or more lookup controls; and upon positive determination, binding the two or more lookup controls using at least one relationship type from the one or more relationship types, wherein at least one of the lookup controls is a parent control and at least one of the lookup controls is a child control.

### TECHNICAL FIELD

Aspects of the present disclosure relate to entity-relationship models and more particularly to systems and methods for binding lookup controls based on relationships between entities in an entity-relationship model.

### BACKGROUND

A common feature in many user interfaces is an input list or lookup control displaying multiple entries and allowing selection of one or more entries. This lookup control may be presented as a dropdown list, a ‘combo box’, an inline list, or a dialog window displaying a list of options. In some cases, an input form may include multiple such lookup controls and a selection made in one such control may govern the options available in another such control. For example, when entering a billing address in an online form, a user may select their country from a list of countries, and then select their state from a list of states. The list of states is often filtered to show only the states that are applicable to the country selected by the user.

Typically these input forms are created in two ways. In the first, purpose specific source code is written to provide for the feature at hand. Alternatively, if the input form is built upon a user-interface creation platform that is coupled to a table-based database, a developer may select a table to source data for each lookup control. Subsequently, a filtering query is developed that filters the table contents to only rows where a nominated column matches a value selected in the lookup control on which the present lookup control depends.

Many platforms are available for creating input forms by drag-dropping one or more lookup controls onto a design surface and then associating those controls in some manner. However, most of these platforms involve manual configuration of the controls or development of source code to bind two or more of the controls.

### SUMMARY

It is an object of the present invention to substantially overcome, or at least ameliorate, one or more disadvantages of existing arrangements. We present the term ReadiNow Intelligent Engines (RIE) to refer to the introduced technology.

Aspects of the present disclosure are directed to one or more methods and systems for binding lookup controls when generating or creating a computer generated input form based on an entity-relationship model. Specifically, entity relationship data is used to drive input forms that have cascading lookup controls where the selection of an option in one list filters the available options in another input list. This entity relationship is utilised by a developed when creating or developing the computer generated input form.

The lookup controls are linked to one another by using a nominated relationship type. Furthermore, in aspects of the present disclosure, a parent control is nominated, and then a relationship type is selected to connect the two or more controls.

According to a first aspect, the present disclosure provides a method for binding two or more lookup controls for use in a computer generated input form, the method comprising: selecting two or more lookup controls for use in the computer generated input form; binding a relationship type from an entity-relationship schema to each of the two or more lookup controls; determining if one or more relationship types exist between the two or more lookup controls; and upon a positive determination, binding the two or more lookup controls using at least one relationship type from the one or more relationship types, wherein at least one of the lookup controls is a parent control and at least one of the lookup controls is a child control.

According to a further aspect, the present disclosure provides system for binding two or more lookup controls for use in a computer generated input form, the system comprising: a memory for storing enterprise-relationship data and a computer program; a processor coupled to said memory for executing said computer program, the computer program comprising instructions for: selecting two or more lookup controls for use in the computer generated input form; binding a relationship type from an entity-relationship schema to each of the two or more lookup controls; determining if one or more relationship types exist between the two or more lookup controls; and upon a positive determination, binding the two or more lookup controls using at least one relationship type from the one or more relationship types, wherein at least one of the lookup controls is a parent control and at least one of the lookup controls is a child control.

According to yet a further aspect, the present disclosure provides computer readable medium having stored thereon a computer program for binding two or more lookup controls for use in a computer generated input form, the computer program configured to: bind a first relationship from an entity-relationship schema to a first lookup control; bind a second relationship from the entity relationship schema to a second lookup control; determine if one or more relationship types exist between the first and second lookup controls; and upon a positive determination, bind the first and second lookup controls using at least one relationship type from the one or more relationship types, wherein at least one of the lookup controls is a parent control and at least one of the lookup controls is a child control.

Further aspects are also described herein and in the attached claims and drawings.

### BRIEF DESCRIPTION OF DRAWINGS

At least one embodiment of the present invention will now be described with reference to the drawings and appendices, in which:

FIG. 1A is a schematic diagram of a cloud platform.

FIG. 1B is a block diagram of a multi-tenanted database.

FIGS. 2A and 2B form a schematic block diagram of a general purpose computer system upon which arrangements described can be practiced.

FIGS. 3A and 3B collectively form a schematic block diagram representation of an electronic device upon which described arrangements can be practiced.

FIG. 4 is a diagram of an example entity-relationship schema.

FIG. 5 is a diagram of an example instance of entity-relationship data that conforms to the schema of FIG. 4.

FIG. 6 is a diagram illustrating a user interface for creating a form and placing lookup controls on the form.

FIG. 7 illustrates a property dialog box of a lookup control.

FIG. 8 is a flowchart illustrating an exemplary method for binding two lookup controls in an input form.

FIG. 9 illustrates a properties dialog box 900 for a child control illustrating settings to bind lookup controls.

FIG. 10 is a diagram illustrating a data structure for binding lookup controls in an input form.

FIG. 11 is a diagram illustrating an instance of the data structure for binding lookup controls in an input form.

FIG. 12 is a flowchart illustrating an exemplary method for determining a list of entity types applicable for a lookup control.

### DETAILED DESCRIPTION

For the purposes of this disclosure, a lookup control is any input list that is able to allow the selection of a single, or possibly multiple, values, where those values correspond to entities in the database. For example, a lookup control may be a combo box, a dropdown box, a list box, a group of checkboxes, a radio box group, an inline picker, a report or query or table that shows multiple options, a type to search input, a chart or diagram that allows selection of data elements, or a popup dialog window of any of these. Significantly, the item being selected represents some entity in an entity relationship database. Some controls lend themselves to selecting a single item (such as a dropdown list or radio group), and some controls lend themselves to selecting multiple items.

Aspects of the present disclosure provide a simple mechanism for binding two or more lookup controls by taking advantage of an entity-relationship schema of an entity-relationship (ER) database.

ER databases provide a natural way of modelling interconnected data. Typically, an ER database or system is used to represent business objects as entities. Accordingly, an entity may represent a physical or abstract object such as a person, country, state, city, or computer, for example. A distinction is made between the type of an entity and the instances of an entity. For example, a ‘country’ may be an entity type, whereas Australia is an instance of the ‘country’ entity. Furthermore, entities may be stored in the database with fields, such as a person's name, employee ID, a computer's model number, etc.

Entities in an ER database are connected to each other by relationships. For example, a person may reside in a particular country, a car may be manufactured by a company, or a computer may be operated by an employee. In this example, ‘resides in’, ‘manufacture by’ and ‘operated by’ are relationships between the entities person and country, car and company, and computer and employee, respectively. Similar to entities, a distinction can be made between the type of a relationship and instances of that relationship. For example, cars in general can be related to their manufacturers, and their drivers. However, a particular car is related to a particular car model, or a particular driver. Note that a car has one model but may have zero, one or many drivers. The type of relationship specifies the cardinality of the relationship, namely whether multiple entities may be related as well as whether those relationships are exclusive. Information about entity types, relationship types, and their cardinality is often collectively referred to as schema. Schema is the information about the structure of data.

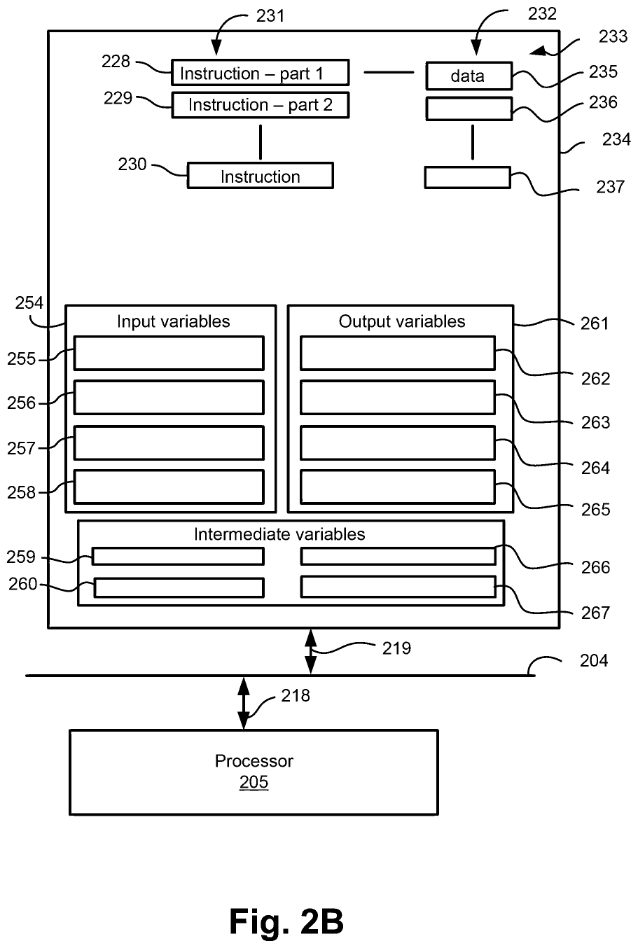

FIG. 4 illustrates an exemplary ER schema 400 that will be utilized throughout this disclosure to describe aspects of the present invention. The schema 400 includes four entity types interrelated through five relationship types. The entity types are represented as boxes whereas the relationship types are represented as arrows. Each relationship type has a name, and a reverse name that is applicable if the relationship is being considered in the reverse direction. Each entity type has potentially several relationship types coming in or out of it, and each relationship type has a defined entity type as its ‘from’ end and at its ‘to’ end. The four entity types are Person 402, Country 404, State 406 and City 408, and the five relationship types are person's country 410, person's state 412, person's city 414, state in country 416, and city in state 418.

### Cloud Platform

According to one aspect, the lookup controls may be configured on a cloud platform, which provides a web-based service empowering users to solve their own business problems by creating their own web or desktop software applications without the need of computer programming or other technical knowledge. Further, web or desktop software applications created using the cloud platform may be customized.

The cloud platform also relieves the burden of important, but distracting, activities such as backup, security, scalability, and so on by providing these services within the platform itself.

Software applications can be built by users themselves, or they can be selected from a suite of pre-written applications, which are then customized by the user. It will be understood that the cloud platform is not limited to certain software applications and so the software applications may be as varied as imagination permits. For example, the software applications may be directed towards customer relationship management, business continuity management, expense tracking, and so on.

The software applications include various software modules that logically make up a software experience, such as dashboards, data entry forms, reports, input forms, as well as interactivity such as running workflows, triggering business processes, importing and exporting data, template document generation, email notifications, and so on.

At the heart of the cloud platform is a purpose built entity-relationship database. All data in the database is modelled as entities and the entities are associated with each other through relationships. A user may configure their own types of relationships between distinct entities to build an interconnected web of data. These relationships can then be traversed when generating visualizations.

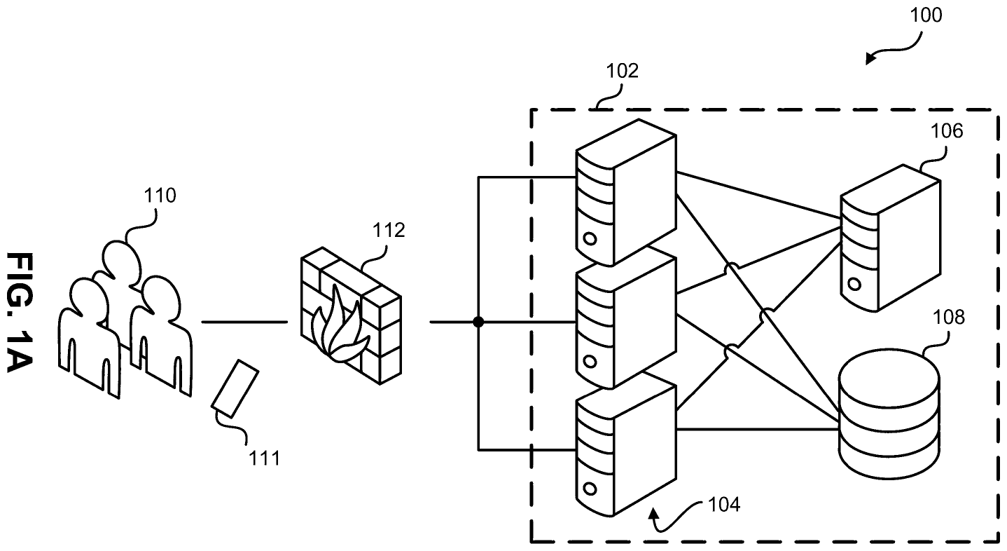

FIG. 1A is a schematic diagram illustrating the physical infrastructure 100 of an exemplary cloud platform 102. The cloud platform 102 is arranged in a fairly typical N-tier architecture including a plurality of front end web servers 104, a cache server 106, and a database server 108 for storing the ER data. The cloud platform 102 may receive web requests from customers 110 using a user device such as a smartphone 111, for example, by an application delivery controller (ACD) 112 that routes requests to the front-end web server 104. The majority of the platform software resides on the front-end web servers 104, whereas the ER data resides in the database server 108. The cache server 106 may temporarily store an ER schema associated with a particular entity for fast access.

The database server 108 may host multiple clients (tenants). Each storage area for each tenant can have different versions of different applications installed. Separate from the tenants, an application library hosts every available version of every available application. User data is also stored within the storage area associated with each tenant FIG. 1B depicts a block diagram of an exemplary multi-tenanted database server 108, including storage areas 150, 152, and 154 for three tenants and an application library 160. A single set of database tables may hold all entity-relationship data for all tenants.

All user data is represented as entities and relationships, as described above. Moreover, the schema (or metadata) about the applications is also described using entities and relationships. The types of entities that are possible; the fields that they may possess; the relationship types that are defined; and the rules for validating input are all described using entities and relationships.

This unique cloud platform 102 structure means that all software modules developed to power the cloud platform 102 equally enrich the user's web-based applications, and vice versa.

As described previously, the above systems run on the cloud platform 102. Additionally, a body of code (a software client) is sent to and runs on the user's web browser. This code is configured to provide a user interface for creating lookup controls and binding two or more lookup controls based on the ER data.

The software client is structured as a single paged application (SPA), whereby all code is loaded upfront, and communication only goes back to the cloud platform 102 to fetch or modify data.

### Computing Device

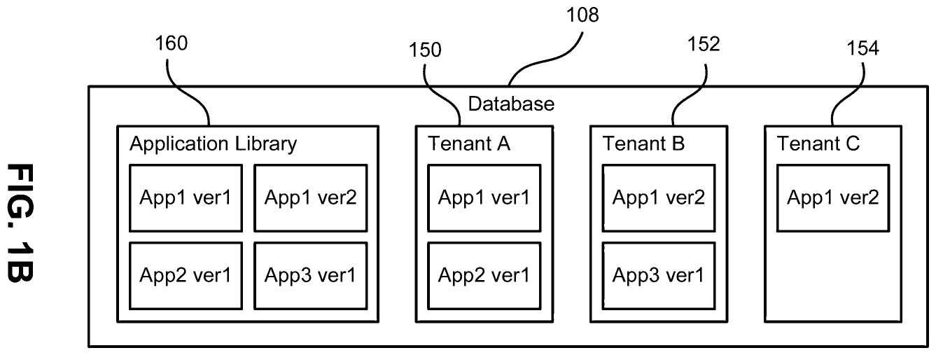

FIGS. 2A and 2B depict a general-purpose computer system 200, upon which the various arrangements described in the present disclosure can be practiced. For instance, users 110 may utilize computer system 200 to create and bind lookup controls based on the ER data stored in the database 108.

As seen in FIG. 2A, the computer system 200 includes: a computer module 201; input devices such as a keyboard 202, a mouse pointer device 203, a microphone 280; and output devices including a printer 215, and a display device 214. An external Modulator-Demodulator (Modem) transceiver device 216 may be used by the computer module 201 for communicating to and from the cloud platform 102 via a connection 221.

The computer module 201 typically includes at least one processor unit 205 and a memory unit 206. For example, the memory unit 206 may have semiconductor random access memory (RAM) and semiconductor read only memory (ROM). The computer module 201 also includes a number of input/output (I/O) interfaces including: an audio-video interface 207 that couples to the video display 214 and microphone 280; an I/O interface 213 that couples to the keyboard 202, mouse 203 and optionally a joystick or other human interface device (not illustrated); and an interface 208 for the external modem 216 and printer 215. In some implementations, the modem 216 may be incorporated within the computer module 201, for example within the interface 208.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Bluray Disc™), USB-RAM, portable, external hard drives, and floppy disks, for example, may be used as appropriate sources of data to the system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practiced include IBM-PC's and compatibles, Apple Mac™ or like computer systems.

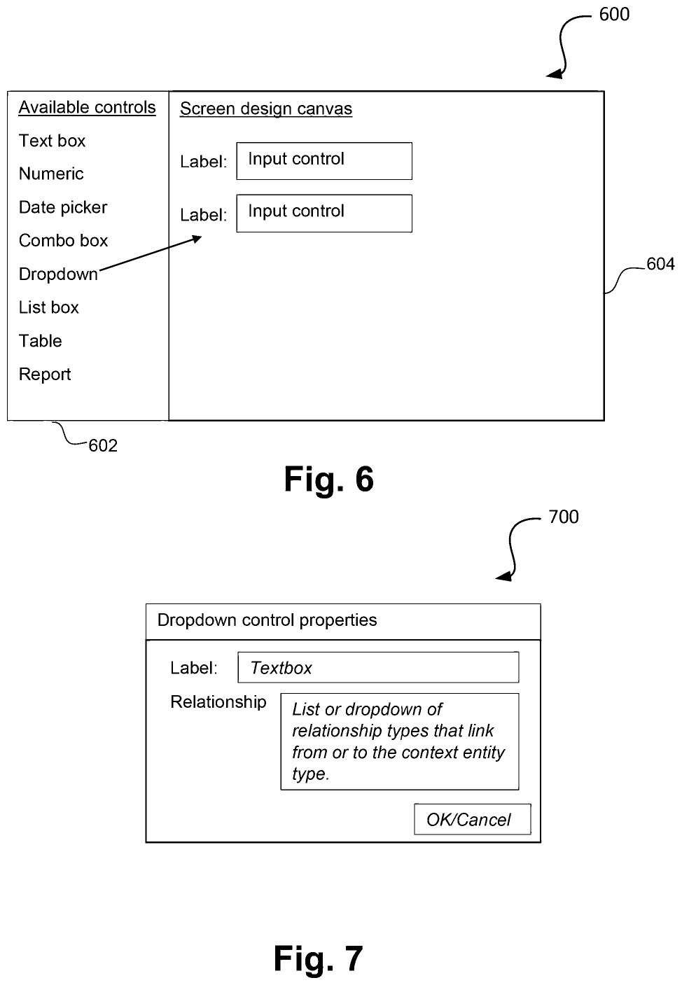

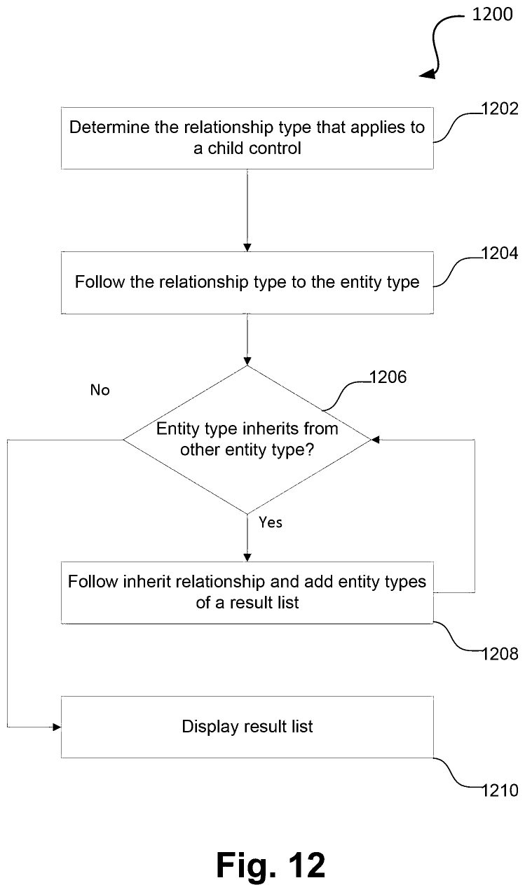

The methods of creating and binding lookup controls based on ER data may be implemented using the computer system 200 wherein the process of FIGS. 8 and 12 to be described, may be implemented as one or more software application programs 233 executable within the computer system 200. In particular, the steps of the methods of binding lookup controls are effected by instructions 231 (see FIG. 2B) in the software 233 that are carried out within the computer system 200. The software instructions 231 may be formed as one or more code modules, each for performing one or more particular tasks. For example, the software may be divided into a code model for managing a user interface 280 that allows a user to design an input form and add lookup controls to the input form based on underlying ER data and an input module 282 that is configured to accept user selections, such as selection of an entity type, a relationship type, and a relationship type to bind two or more lookup controls. The software may also include an output module 286 to display a design canvas for adding lookup controls and properties dialogs for binding the lookup controls.

The software may be downloaded from the cloud platform 102 and stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for generating visualizations based on ER data.

In some instances, the application programs 233 may be read by the user from the cloud platform 102. Application programs that have been read from the cloud platform may be stored on the computer system in memory 206 or cached on computer readable storage media for fast access. Computer readable storage media refers to any non-transitory tangible storage medium that provides recorded instructions and/or data to the computer system 200 for execution and/or processing. Examples of such storage media include a hard disk drive, USB memory, a magneto-optical disk, or a computer readable card such as a PCMCIA card and the like, whether or not such devices are internal or external of the computer module 201. Examples of transitory or non-tangible computer readable transmission media that may participate in the provision of software, application programs, instructions and/or data to the computer module 201 include radio or infra-red transmission channels as well as a network connection to another computer or networked device, and the Internet or Intranet including information recorded on Websites and the like.

The second part of the application programs 233 and the corresponding code modules mentioned above may be executed to implement one or more user interfaces UIs to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the UI(s).

FIG. 2B is a detailed schematic block diagram of the processor 205 and a “memory” 234. The memory 234 represents a logical aggregation of all the memory modules (including the HDD 209 and semiconductor memory 206) that can be accessed by the computer module 201 in FIG. 2A.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The disclosed system for creating and binding lookup controls from ER data uses input variables 254, which are stored in the memory 234 in corresponding memory locations 255, 256, 257. The user interface produces output variables 261, which are stored in the memory 234 in corresponding memory locations 262, 263, 264. Intermediate variables 258 may be stored in memory locations 259, 260, 266 and 267.

The methods of binding lookup controls based on ER data may alternatively be implemented in dedicated hardware such as one or more integrated circuits performing the functions or sub functions of FIG. 8. Such dedicated hardware may include graphic processors, digital signal processors, or one or more microprocessors and associated memories.

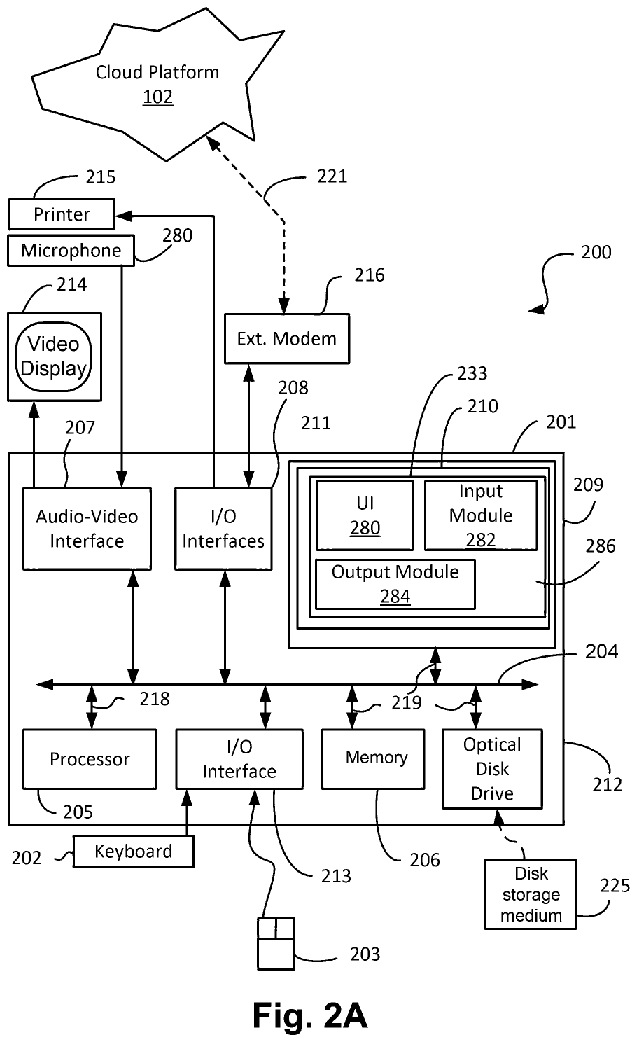

FIGS. 3A and 3B collectively form a schematic block diagram of a general purpose electronic device 301 including embedded components, upon which the herein described methods to be described are desirably practiced. The electronic device 301 may be, for example, a mobile phone, a portable media player or a tablet device, in which processing resources are limited. Nevertheless, the methods to be described may also be performed on higher-level devices such as desktop computers, server computers, and other such devices with significantly larger processing resources.

As seen in FIG. 3A, the electronic device 301 comprises an embedded controller 302. Accordingly, the electronic device 301 may be referred to as an “embedded device.” In the present example, the controller 302 has a processing unit (or processor) 305 which is bi-directionally coupled to an internal storage module 309. The storage module 309 may be formed from non-volatile semiconductor read only memory (ROM) 360 and semiconductor random access memory (RAM) 370, as seen in FIG. 3B. The RAM 370 may be volatile, non-volatile or a combination of volatile and non-volatile memory.

The electronic device 301 includes a display controller 307, which is connected to a video display 314, such as a liquid crystal display (LCD) panel or the like. The display controller 307 is configured for displaying graphical images on the video display 314 in accordance with instructions received from the embedded controller 302, to which the display controller 307 is connected.

The electronic device 301 also includes user input devices 313 which are typically formed by keys, a keypad or like controls. In some implementations, the user input devices 313 may include a touch sensitive panel physically associated with the display 314 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 3A, the electronic device 301 also comprises a portable memory interface 306, which is coupled to the processor 305 via a connection 319. The portable memory interface 306 allows a complementary portable memory device 325 to be coupled to the electronic device 301 to act as a source or destination of data or to supplement the internal storage module 309. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 301 also has a communications interface 308 to permit coupling of the device 301 to a computer or communications network 320 via a connection 321. The connection 321 may be wired or wireless. For example, the connection 321 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 301 is configured to perform some special function. The embedded controller 302, possibly in conjunction with one or more further special function components 310, is provided to perform that special function. The special function components 310 are connected to the embedded controller 302. As another example, the device 301 may be a mobile telephone handset. In this instance, the components 310 may represent those components required for communications in a cellular telephone environment. Where the device 301 is a portable device, the special function components 310 may represent a number of encoders and decoders of a type including Joint Photographic Experts Group (JPEG), (Moving Picture Experts Group) MPEG, MPEG-1 Audio Layer 3 (MP3), and the like.

The methods described hereinafter may be implemented using the embedded controller 302, where the methods of creating and binding lookup controls based on ER data may be implemented as one or more software application programs 233 executable within the embedded controller 302. The electronic device 301 of FIG. 3A implements the described methods. In particular, with reference to FIG. 3B, the steps of the described methods are effected by instructions in the software 233 that are carried out within the controller 302. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 233 of the embedded controller 302 is typically stored in the non-volatile ROM 360 of the internal storage module 309. The software 233 stored in the ROM 360 can be updated when required from a computer readable medium. The software 233 can be loaded into and executed by the processor 305. In some instances, the processor 305 may execute software instructions that are located in RAM 370. Software instructions may be loaded into the RAM 370 by the processor 305 initiating a copy of one or more code modules from ROM 360 into RAM 370. Alternatively, the software instructions of one or more code modules may be pre-installed in a non-volatile region of RAM 370 by a manufacturer. After one or more code modules have been located in RAM 370, the processor 305 may execute software instructions of the one or more code modules.

The application program 233 is typically pre-installed and stored in the ROM 360 by a manufacturer, prior to distribution of the electronic device 301. However, in some instances, the application programs 233 may be supplied to the user encoded on one or more CD-ROM (not shown) and read via the portable memory interface 306 of FIG. 3A prior to storage in the internal storage module 309 or in the portable memory 325. In another alternative, the software application program 233 may be read by the processor 305 from the network 320, or loaded into the controller 302 or the portable storage medium 325 from other computer readable media. Computer readable storage media refers to any non-transitory tangible storage medium that participates in providing instructions and/or data to the controller 302 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 301. Examples of transitory or non-tangible computer readable transmission media that may also participate in the provision of software, application programs, instructions and/or data to the device 301 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 233 and the corresponding code modules mentioned above may be executed to implement one or more graphical user interfaces (GUIs) to be rendered or otherwise represented upon the display 314 of FIG. 3A. Through manipulation of the user input device 313 (e.g., the keypad), a user of the device 301 and the application programs 233 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 3B illustrates in detail the embedded controller 302 having the processor 305 for executing the application programs 233 and the internal storage 309. The internal storage 309 comprises read only memory (ROM) 360 and random access memory (RAM) 370. The processor 305 is able to execute the application programs 233 stored in one or both of the connected memories 360 and 370. When the electronic device 301 is initially powered up, a system program resident in the ROM 360 is executed. The application program 233 permanently stored in the ROM 360 is sometimes referred to as “firmware”. Execution of the firmware by the processor 305 may fulfil various functions, including processor management, memory management, device management, storage management and user interface.

The processor 305 typically includes a number of functional modules including a control unit (CU) 351, an arithmetic logic unit (ALU) 352, a digital signal processor (DSP) 353 and a local or internal memory comprising a set of registers 354 which typically contain atomic data elements 356, 357, along with internal buffer or cache memory 355. One or more internal buses 359 interconnect these functional modules. The processor 305 typically also has one or more interfaces 358 for communicating with external devices via system bus 381, using a connection 361.

The application program 233 includes a sequence of instructions 362 through 363 that may include conditional branch and loop instructions. The program 233 may also include data, which is used in execution of the program 233. This data may be stored as part of the instruction or in a separate location 364 within the ROM 360 or RAM 370.

In general, the processor 305 is given a set of instructions, which are executed therein. This set of instructions may be organised into blocks, which perform specific tasks or handle specific events that occur in the electronic device 301. Typically, the application program 233 waits for events and subsequently executes the block of code associated with that event. Events may be triggered in response to input from a user, via the user input devices 313 of FIG. 3A, as detected by the processor 305. Events may also be triggered in response to other sensors and interfaces in the electronic device 301.

The execution of a set of the instructions may require numeric variables to be read and modified. Such numeric variables are stored in the RAM 370. The disclosed methods uses input variables 371 that are stored in known locations 372, 373 in the memory 370. The input variables 371 are processed to produce output variables 377 that are stored in known locations 378, 379 in the memory 370. Intermediate variables 374 may be stored in additional memory locations in locations 375, 376 of the memory 370. Alternatively, some intermediate variables may only exist in the registers 354 of the processor 305.

The execution of a sequence of instructions is achieved in the processor 305 by repeated application of a fetch-execute cycle. The control unit 351 of the processor 305 maintains a register called the program counter, which contains the address in ROM 360 or RAM 370 of the next instruction to be executed. At the start of the fetch execute cycle, the contents of the memory address indexed by the program counter is loaded into the control unit 351. The instruction thus loaded controls the subsequent operation of the processor 305, causing for example, data to be loaded from ROM memory 360 into processor registers 354, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 233, and is performed by repeated execution of a fetch-execute cycle in the processor 305 or similar programmatic operation of other independent processor blocks in the electronic device 301.

### Exemplary System

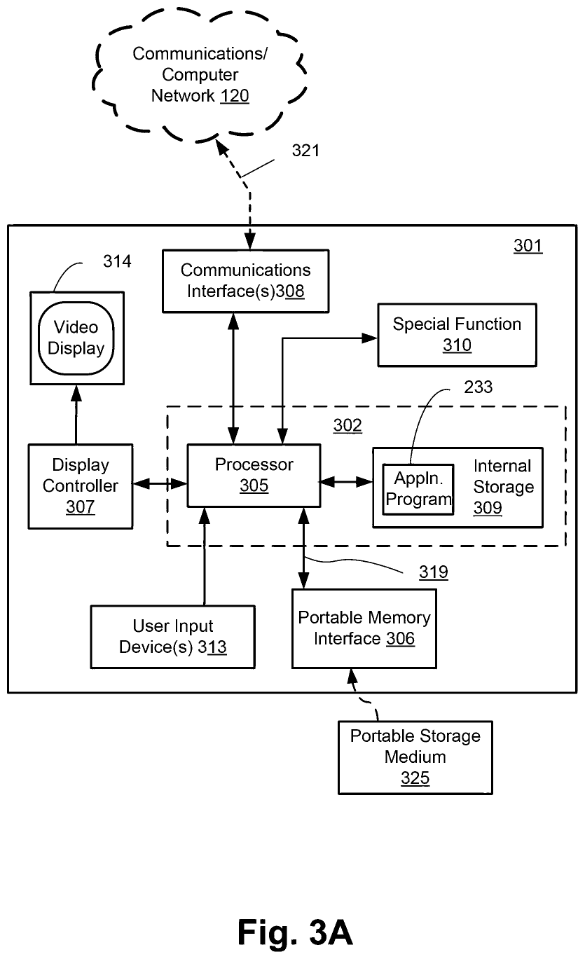

FIG. 5 illustrates exemplary ER data based on the ER schema 400 that will be used throughout this description.

The boxes 502-524 indicate entity instances, with the entity type of each instance in brackets. Arrows represent relationship instances; each arrow shows the name of the relationship type. Note that every relationship instance is of a relationship type and that the entities at either end of the relationship instance are of types that correspond to the required entity types for each end of the relationship type. For example, the relationship instance ‘Cities’ connects from NSW 510 to Sydney 516. This is aligned with the schema 400, in which the relationship type 418 connects the state entity 406 to the city entity 408.

If the user interface 280 is representative of a form for entering or modifying data of a particular type of entity, then the information about what type of entity is being edited is associated with the UI. For example, a screen for editing the details of a person has an association to the ‘person’ entity type. For the purpose of discussion, this will be referred to as the context entity type.

### Exemplary Method

FIG. 8 is a flowchart illustrating an exemplary method 800 for binding two lookup controls in an input form. The method begins at step 802 where a user may add a first dropdown to an input form and link the dropdown to a relationship. Adding a lookup control (such as a combo box, or a list box, selection dialog, or other mechanism for selecting an entity) can be achieved by a drag-drop interface or other mechanism for dropping the selected lookup control from a list of lookup controls onto a design surface of the UI and then nominating a relationship type from the ER schema 400 that points from or to the context entity type.

For example, the application designer of an input form for entering a person's details may drop a combo box onto the design surface and then nominate the “Person's country' relationship. By default, this combo box would then list all available countries. In the illustrated example (i.e., FIG. 5), the combo box would list Australia, France and USA. Viewing this input form for a given user (for example, Amanda) would show the selected entity as being the one for which a relationship instance exists from the entity being viewed/edited of the nominated relationship type (namely Person's country). For example, Australia would appear selected because there is a relationship instance between the Amanda and Australia entities, and that relationship instance is of type “Person's country”. (Relationships between relevant endpoints that are of a different relationship type are not applicable, as they may represent something completely unrelated, such as the person's last holiday destination for example).

Therefore, each lookup control is associated with a relationship type, and either the from-end or the to-end of that relationship type matches the context entity type. Alternatively, if the database supports type inheritance, then the lookup control matches the context entity type or an ancestor type of the context entity type.

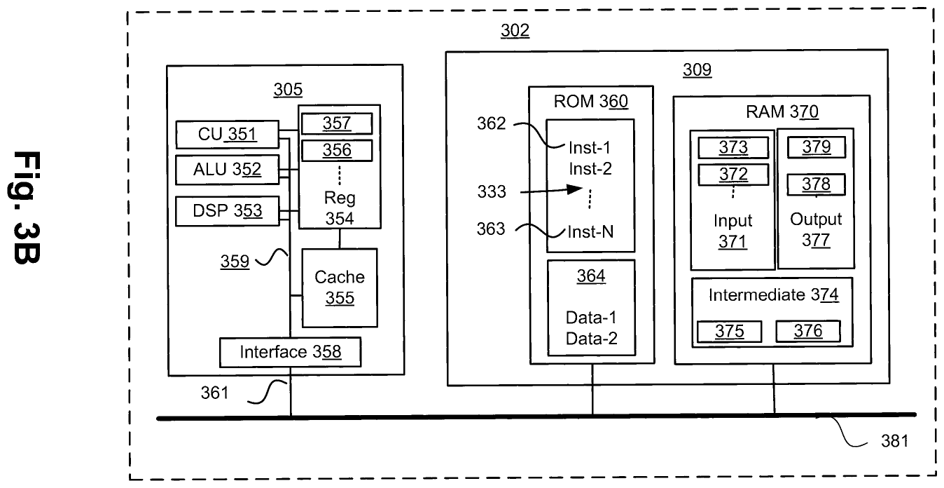

FIG. 6 is a diagram illustrating one possible user interface 600 for selecting lookup controls. The user interface 600 includes an area 602 that depicts all the available form controls, including lookup controls such as combo box, dropdown, list box, table, and report, as well as other controls such as textbox, numeric, date picker. The user interface 600 further includes a design canvas area 604. A user may select one or more of the form controls, including lookup controls, and add them to the design canvas area 604 to design an input form. Selection may be performed using any known technique such as dragging a control from the area 602 and dropping the control in the design canvas area 604, double clicking, single clicking, etc. In the example depicted in FIG. 6, the user has drag-dropped a dropdown lookup control onto the design canvas area 604.

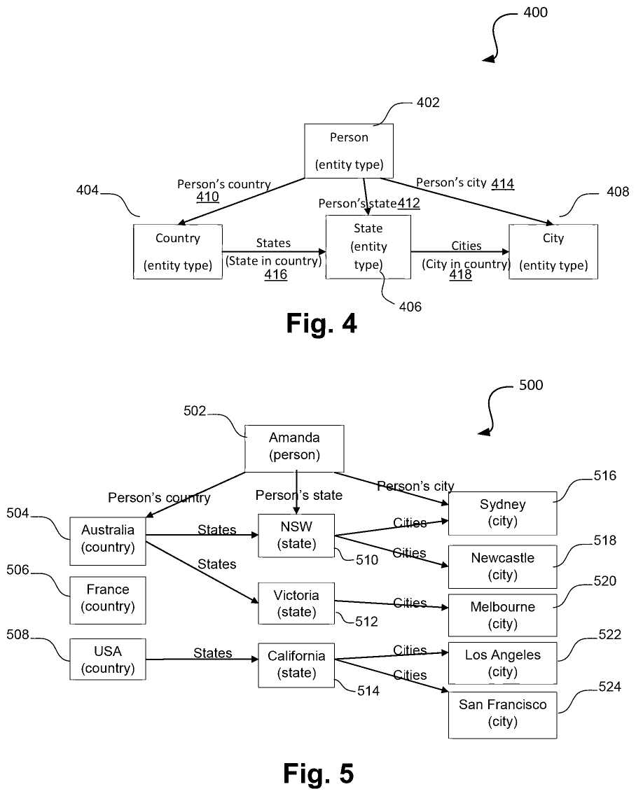

FIG. 7 illustrates a property page 700 that may be utilized to select a relationship for the selected lookup control. A relationship section 702 in the property page 700 may show a list of all relationships that link from or to the context entity type of the form. For instance, if the form being designed applies to the entity type ‘person’, the properties page may display all the relationships from the person entity such as ‘person's country’ 410, ‘person's state’ 412, and ‘person's city’ 414.

It will be understood that the direction of a relationship may be significant. If a relationship type connects endpoints of different entity types then the direction is usually intuitive, but if the relationship connects two endpoints of the same entity type then the direction of the relationship may not be so intuitive. For example, consider an ER schema which includes the entity type ‘employee’. This entity type may include managers and their subordinates. A relationship between managers and subordinates may be between entity types ‘employee’ and ‘employee’ for example, but in one direction the relationship indicates a person's manager, and the same relationship in the opposite direction indicates the person's subordinate. Therefore, wherever a relationship type is recorded or utilised (such as above for a control, or below for a binding, the direction of that relationship type may also be recorded or utilised).

Specifically, a relationship may be selected for use by a lookup control in either direction so long as the entity type at the applicable end of the relationship matches the context entity type. For example, a relationship type from person to any other type may be used on a person input form in the forward direction. A relationship type from any entity type to a person type may be used on the person form in the reverse direction.

If a relationship type is selected in a lookup control, then the entity type at the opposite end of the relationship drives the type of entities that may be selected. For example, if we use “Person's city” on a “person” input form in the forward direction, then the control displays cities, because ‘city’ is the entity type at the other end of the relationship definition. This will be referred to as the ‘target type’, without specific regard to the actual direction that the relationship was followed (i.e., if we follow the relationship in reverse then the target type is in fact the “from” type of the relationship type).

At step 804, a second control may be added to the input form and linked to a relationship similar to step 802. For example, in the ‘person’ input form that already has a lookup control for the ‘person's country’ a second lookup control can be added and linked to the relationship ‘person's state’.

Subsequently (at step 805), it is determined whether a relationship exists between the first and second controls. If the target type of the first and second controls is such that there exists one or more relationships between the first and second controls, then there exists an opportunity to bind the two lookup controls such that one control depends on the other. In the present example, a relationship exists between the two controls ‘person's country’ and ‘person's state’, namely ‘country's states’. Because this relationship exists between the two lookup controls, they can be bound to each other. If no such relationship exists, the method ends.

At step 806, upon positive determination of a relationship between the first and second controls, the first control and the second control are bound at step 808. For binding, the lookup control that has its content filtered is referred to as the child control, and the lookup control based on which the child control is filtered is referred to as the parent control.

A user may select one of the lookup controls, such as the control representing “Person's state” in this example, and access properties of that control (this control will be the child control). One property of the control may allow the control to be bound to the other control as the parent by allowing the user to select the other control on the input form. Alternatively, the property may only display applicable controls for which one or more bindings are possible. When the user selects a control to bind to, the opposite end type entity for both the child control and parent control are determined, and all possible relationships between the two in either direction may be displayed as candidates for binding.

For example, if “Person's state” is configured to be the child control, and “Person's country” is selected to be the parent control, then the system identifies the entities state and country as being the two opposite end types, and identifies that there exists a ‘states in country’ relationship between the two end entities. The property may also display the relationship in the reverse direction, namely ‘states country’

At step 810, a binding relationship type is selected for the binding. In the illustrated example, one binding relationship (country's state) exists between the two controls. However, in other ER schemas, multiple relationships may exist between two controls. In such cases, the properties dialog box may depict all the available relationships between the controls and allow the user to select a desired relationship type.

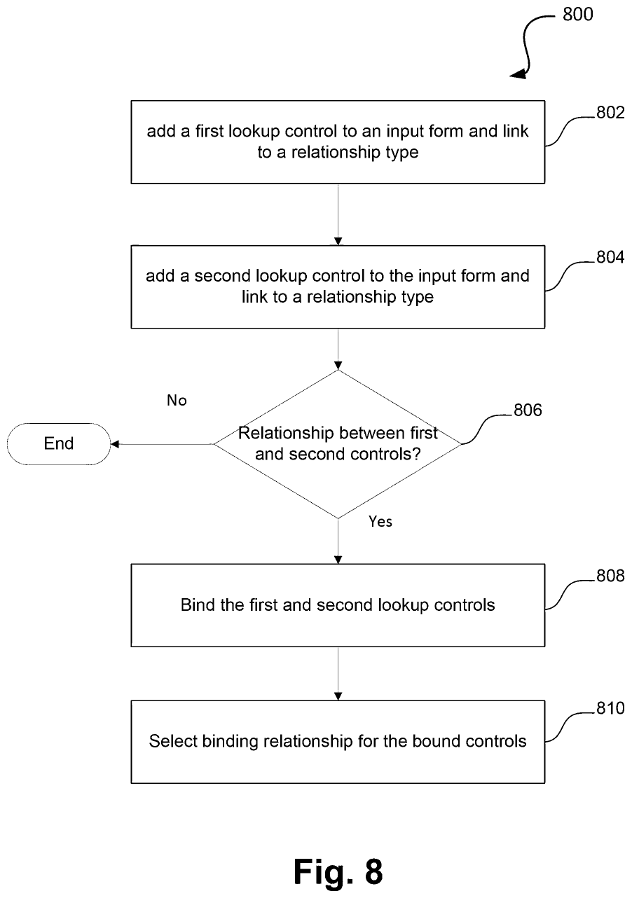

FIG. 9 illustrates a properties dialog box 900 for a child control illustrating settings to bind lookup controls. As illustrated, the control properties dialog box 900 includes a label property 902 indicating the label of the control, a relationship property 904 indicating the relationship bound to the control, a parent property 906 indicating whether the control has an associated parent or child control, and a binding relationship property 908 indicating the relationship type used for the binding. A developer may be allowed to change the properties 902-908 of a control using the dialog box 900. In case a lookup control is not bound to another control, the parent property 906 is not set. Alternatively, if no other lookup controls exist in an input form, the parent property 906 may be hidden or disabled. In the above two cases, the binding relationship property 908 is also not applicable, and either the list of options displayed against this property is empty or that whole setting is disabled/hidden.

It will be appreciated that the layout of the dialog box 900 may vary considerably. For instance the properties dialog box 900 may include multiple other options and settings, which are often grouped into sections or tabs.

The following relationship types may be displayed in the properties dialog box 900:

1. The forward direction name of relationships that have their from-end matching an entity type that is equal to the opposite-end type of the child control, and the to-end matching the opposite-end type of the parent control that was selected.
2. The reverse name of relationships that have their to-end matching a type that is equal to the opposite-end type of the child control, and the from-end matching the opposite-end type of the parent control that was selected.
3. Other relationships that match the above, except where the relationship endpoint type matches an ancestor type of the opposite-end type of either control.

For example, the relationship types that may be displayed for the control ‘Person's state’ when ‘Person's country’ is selected as the parent, include any relationship type from Country to State (forward direction) or from State to Country (reverse direction). If a hypothetical entity-type ‘Location’ is also present in the schema and if either or both of State or Country are inherited from Location, then relationships from or to Location would also be displayed.

In some embodiments, an input form may be created with multiple controls having unrelated bindings. For instance, an input form may be created with 4 controls, where control 2 is bound to control 1 and control 4 is bound to control 3. In other embodiments, two children controls may have the same parent control. For example, controls 2 and 3 may be bound to control 1 and both the children controls may specify the same binding relationship type or different binding relationship types. Consider the example of a domestic flight booking system, which allows a user to select a country and then origin and destination states. Both the origin and destination state lists may be children controls of the country control so that both the children controls are filtered to the same states when the country is selected. However, it will be appreciated that the children controls store their values distinctly in their own context relationships, i.e., person has flight origin state, and person has flight destination state.

In another aspect, a lookup control can act as a parent and a child control simultaneously. Consider an input form having three controls, where control 1 represents “Person's country”, control 2 represents “Person's state”, and control 3 represents “Person's city”. In this case, control 2 may be bound to control 1 along the “State's country” reverse relationship, and control 3 may be bound to control 2 along the “City's state” reverse relationship. In this way, when the end user selects a country in control 1, a list of valid states is shown in control 2, and then when they select a state in control 2, a list of valid cities is shown in control three.

Any number of lookup controls may be structured to cascade or fan out without departing from the scope of the present disclosure. Alternatively, the system may detect and impose limits on the number of lookup controls. The invention employs a mechanism to prevent circular dependencies between controls in bindings and prohibit the application developer from creating screens with such circular dependencies. This can be achieved by repeatedly following from each child lookup control to its parent control, and determining if following this path eventually leads back to the original child control that is being configured.

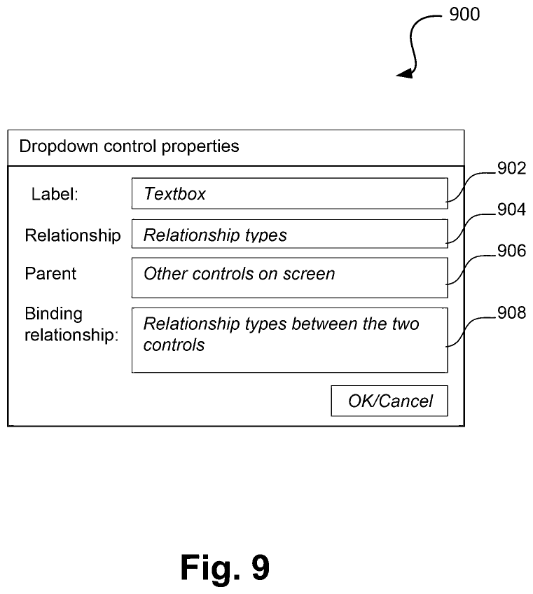

One possible implementation of a data structure is depicted in FIG. 10. Other implementations can be readily imagined. The application data may be stored in an entity-relationship database, in the same manner as customer data; however, this is not essential.

Blocks 1002-1008 represent entity types. Note that there is an entity type to represent entity types which are relevant to this diagram. Each relationship type 1008 refers to an entity type 1004 to indicate the valid entity types that are permitted at the ‘from’ and ‘to’ end of a relationship. The input form 1002 also indicates what entity type it applies to. Furthermore, input forms 1002 directly or indirectly relates to lookup controls 1006 present in the input form.

The key elements of the control entity 1006 are the relationship to the relationship type entity 1008 that indicates what type of relationship is being represented, the relationship back to a different instance of lookup control that indicates the parent control and another relationship to the relationship type entity 1008 that indicates what relationship is used to filter the child control. The lookup control entity 1006 also includes two fields that indicate direction, one for each of the two relationships that the relationship type depends on.

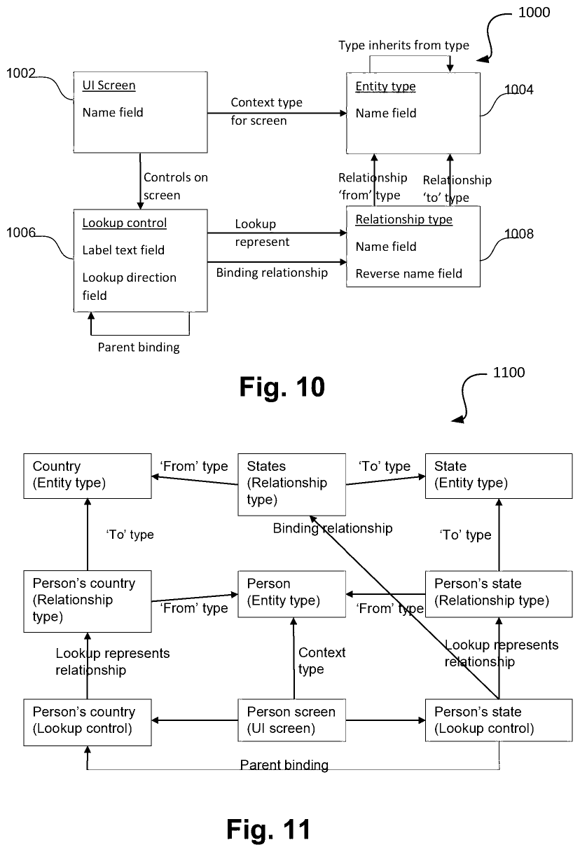

The ER data 500 illustrates a concrete set of instances for the data structure 1000 as depicted in FIG. 11. This example 1100 illustrates a ‘Country’ dropdown, a ‘State’ dropdown that is bound to it, and the relevant entity types and relationships that are involved. Each box in FIG. 11 represents an entity, and the type of entity is shown in brackets. Each arrow represents a relationship instance between the two entities, and the relationship type named in the arrow label.

FIG. 12 is a flowchart illustrating an exemplary method for determining the list of entity types that may be applicable for any given lookup control. The method begins at step 1202 where the ‘lookup represents relationship’ relationship in FIG. 10 is followed to determine the relationship type 1008 that the child control 1006 applies to. Next at step 1204, the determined relationship type is followed to the entity type 1004. If the ‘lookup direction field’ of the child control 1006 is forward, then the ‘to’ relationship is followed from the relationship type 1008 to the entity type 1004. Alternatively, if the ‘lookup direction field’ of the child control 1006 is reverse, then the ‘from’ relationship is followed from the relationship type 1008 to the entity type 1004. This entity type is noted in the result set. Subsequently, at step 1206, the method determines if the entity type inherits from any other entity types. If yes, the ‘inherits’ relationship is followed and those entity types are added to the result set at step 1208. Steps 1206 and 1208 are performed recursively until no more ancestors are found. When no more ancestors are found at step 1206, the method proceeds to step 1210 where the updated result set is displayed.

Therefore, the system, method and associated program is arranged to determine if one or more relationship types exist between the two or more lookup controls by: determining a relationship type and direction represented by each lookup control; determining a target type of the relationships, taking the determined direction into consideration; determining all ancestor types that the determined target types inherits from; and determining all relationship types that connect from the target type of the first control, or one of its ancestor types, to the target type of the second control, or one of its ancestor types, in either the forward or reverse direction.

The output of method 1200 may be utilized to determine one or more controls that may be used as binding parents for a child lookup control. Specifically, other controls in the input form 1002 can be accessed by following the relationship from the potential child lookup control to the input form 1002 and from the input form 1002 to all lookup controls 1006 in the input form. Every control in the input form may be visited except the potential child control. For each control in turn, the set of entity types that may be applicable is determined, using method 1200. If any relationship types 1008 exist that have one of the entity types 1004 in the result set as its ‘to’ type, and one of the entity types in the set of entity types for the current child control, or vice-versa, then this control is a candidate for being a binding parent, and is shown in the list of possible options.

When a control is selected in the dropdown to be the binding parent, the same method may be utilised, except all the controls are not assessed and only the selected control is assessed and the list of all relationship types between the selected control and the potential control is displayed.

If a lookup control is removed from an input form, any binding relationships that the removed control had to other controls are also removed. In particular, if a parent control is removed, then any binding children controls are updated to remove any references to binding with the parent. The removal may be cascaded to all bound children controls in one aspect.

When an end user uses the input form created using method 800, the lookup controls take on the values related to the user. For instance, if the end user is Amanda, the country dropdown will show Australia as that is the country that is related to the Amanda entity by the ‘person's country’ relationship. Furthermore, the options that are displayed in a child control are updated whenever the value in a parent control is updated. For example, if Australia is selected in the country control then the “Person's state” control will be updated to only show “NSW” and “Victoria”. Moreover, if the currently selected value in the child control is no longer applicable then that value is either maintained, cleared, or set to the first available option in the list. Whenever the value of a control that acts as a parent and a child changes, the children nodes are also updated.

When the input form is used for modifying or entering data, it may be that an existing record is opened up that contains relationship values relevant to the parent control and child control that do not have a valid relationship between them. Or it may be possible that either there is no value set to show on either the parent control or the child control. For example, the Amanda entity example may not have had a relationship to any state, but only to a country or vice-versa. Or the entity may have been related to an invalid combination, such as having a relationship to the “US” country, but a relationship to the “NSW” state. When accessing this record, this invention will show whatever the presently recorded value is within the control, and then show only options for selection that are legitimate for the parent control. The system may also alert the user to the inconsistency. For example, if only a state is selected (to NSW), then the country dropdown will have no value set, and the state dropdown will have only a single value for NSW. Alternatively, if the country and state were set to US/NSW respectively, then the state dropdown will show NSW selected in addition to options that are applicable to the US, namely California.

When a value is loaded into the parent control, or modified in the parent control, the mechanism works as follows:

1. The newly selected value is noted
2. The “parent binding” relationship is followed in reverse to determine what controls, if any may be binding children of the current control.
3. For each of those controls:
4. All options in the child control are removed (optionally leaving the one that is selected)
5. The “binding relationship” and “binding direction” are determined for the current lookup control.
6. If the binding direction is forwards, then:
a. All relationship instances of a type that match the binding relationship, and that have the value from step 1 as their ‘from’ instance, are returned and the ‘to’ instance is added to the result list.
7. If the binding direction is reverse then:
a. All relationship instances of a type that match the binding relationship, and that have the value from step 1 as their ‘to’ instance, are returned and the ‘from’ instance is added to the result list.
8. The result list is added to the lookup control
9. This entire process is then performed recursively to see if the newly updated control also has child controls cascading.
10. Control returns to step 3 until all controls are completed.

In some aspects, the input form may be utilized to create or modify an entity. In this case, the UI transmits the user data back to the ER database. This transfer may happen immediately, or it may happen when the user specifically selects save. Because actual selections of lookups are represented as relationships between the context entity (for example the person entity), and individual instances of the opposite-ends types (e.g. the countries, states, cities), when changes are saved, any old relationship instances are removed and new ones are created.

Aspects of the present disclosure therefore provide a method and user interface for creating and binding lookup controls based on ER data without the need of first converting the ER data into a tabular format or developing source code. By binding the controls based on the existing relationships between entities, aspects of the present disclosure provide a simple and user friendly interface that allows even novice users to generate input forms.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method for binding two or more lookup controls for use in a computer generated input form, the method comprising:
selecting two or more lookup controls for use in the computer generated input form;
binding a relationship type from an entity-relationship schema to each of the two or more lookup controls;
determining if one or more relationship types exist between the two or more lookup controls; and
upon a positive determination, binding the two or more lookup controls using at least one relationship type from the one or more relationship types, wherein at least one of the lookup controls is a parent control and at least one of the lookup controls is a child control.

2. The method of claim 1 further comprising:
generating the computer generated input form with the two or more lookup controls.

3. The method of claim 1 further comprising:
filtering a list of entries in the child control based on the selection of an entry in the parent control.

4. The method of claim 1, wherein the step of determining if one or more relationship types exist between the two or more lookup controls further comprises the steps of:
determining a direction associated with the relationship type associated with each of the two or more lookup controls;
determining a target type of the relationship type based on the determined direction;
determining ancestor types associated with the determined target type; and
determining, in either the forward or reverse direction, all relationship types that connect from the determined target type or determined ancestor type of a first lookup control to the determined target type or determined ancestor type of a second lookup control.

5. A system for binding two or more lookup controls for use in a computer generated input form, the system comprising:
a memory for storing enterprise-relationship data and a computer program;
a processor coupled to said memory for executing said computer program, the computer program comprising instructions for:
selecting two or more lookup controls for use in the computer generated input form;
binding a relationship type from an entity-relationship schema to each of the two or more lookup controls;
determining if one or more relationship types exist between the two or more lookup controls; and
upon a positive determination, binding the two or more lookup controls using at least one relationship type from the one or more relationship types, wherein at least one of the lookup controls is a parent control and at least one of the lookup controls is a child control.

6. The system of claim 5, wherein the computer program further comprises instructions for generating the computer generated input form with the two or more lookup controls.

7. The system of claim 5, wherein the computer program further comprises instructions for filtering a list of entries in the child control based on the selection of an entry in the parent control.

8. The system of claim 5, wherein the computer program instructions for determining if one or more relationship types exist between the two or more lookup controls comprises further instructions for:
determining a direction associated with the relationship type associated with each of the two or more lookup controls;
determining a target type of the relationship type based on the determined direction;
determining ancestor types associated with the determined target type; and
determining, in either the forward or reverse direction, all relationship types that connect from the determined target type or determined ancestor type of a first lookup control to the determined target type or determined ancestor type of a second lookup control.

9. A computer readable medium having stored thereon a computer program for binding two or more lookup controls for use in a computer generated input form, the computer program configured to:
bind a first relationship from an entity-relationship schema to a first lookup control;
bind a second relationship from the entity relationship schema to a second lookup control;
determine if one or more relationship types exist between the first and second lookup controls; and
upon a positive determination, bind the first and second lookup controls using at least one relationship type from the one or more relationship types, wherein at least one of the lookup controls is a parent control and at least one of the lookup controls is a child control.

10. The computer readable medium of claim 9, wherein the computer program is further configured to generate the computer generated input form with the first and second lookup controls.

11. The computer readable medium of claim 9, wherein the computer program is further configured to filter a list of entries in the child control based on the selection of an entry in the parent control.

12. The computer readable medium of claim 9, wherein the computer program is further configured to determine if one or more relationship types exist between the two or more lookup controls by:
determining a direction associated with the relationship type associated with each of the two or more lookup controls;
determining a target type of the relationship type based on the determined direction;
determining ancestor types associated with the determined target type; and
determining, in either the forward or reverse direction, all relationship types that connect from the determined target type or determined ancestor type of a first lookup control to the determined target type or determined ancestor type of a second lookup control.
